(19) United States
(12) Patent Application Publication
(10) Pub. No.: US 2017/0149320 A1
(43) Pub. Date: May 25, 2017

(54) VIBRATION MOTOR, SILENT NOTIFICATION DEVICE, AND METHOD OF MANUFACTURING VIBRATION MOTOR

(71) Applicant: Nidec Seimitsu Corporation, Ueda-shi (JP)

(72) Inventors: Zendi MORI, Ueda-shi (JP); Takayuki TAKEUCHI, Ueda-shi (JP)

(21) Appl. No.: 15/359,659

(22) Filed: Nov. 23, 2016

(30) Foreign Application Priority Data
Nov. 25, 2015 (JP) 2015-229535

(51) Int. Cl. H02K 33/18; H02K 15/14

(52) U.S. Cl. CPC H02K 33/18; H02K 15/14

(57) ABSTRACT

A vibration motor includes a base portion, a magnet portion, an annular vibrating portion including a coil portion, and a mass portion, the vibrating portion being arranged around the magnet portion; a cover portion fixed to the base portion, and arranged to cover upper and lateral sides of the vibrating portion; and an annular elastic member arranged between the cover portion and the vibrating portion, and joined to both the upper portion of the cover portion and the vibrating portion. An inner edge portion of the elastic member is arranged radially inward of an inner circumferential edge of the mass portion. The inner edge portion of the elastic member includes a positioning portion defined therein. An outer surface of the upper portion of the cover portion includes a joint portion indicating a position at which the cover portion and the elastic member are joined to each other.

### CROSS REFERENCE TO RELATED APPLICATIONS

This application claims the benefit of priority to Japanese Patent Application No. 2015-229535 filed on Nov. 25, 2015. The entire contents of this application are hereby incorporated herein by reference.

### BACKGROUND OF THE INVENTION

1. Field of the Invention

The present invention relates to a vibration motor, a silent notification device, and a method of manufacturing the vibration motor.

2. Description of the Related Art

In recent years, vibration motors that cause a vibrating portion to vibrate in a vertical direction through interaction between a coil and a magnet arranged in a radial direction have often been used as silent notification devices in mobile communication apparatuses or the like or for other purposes.

In the case of a linear vibrator described in JP-A 2013-85438, when an elastic member 140 and a holder 136, to which a coil 132 is joined, are joined to each other through welding, laser beams for welding are emitted into a case 112 through holes 116 defined in an upper surface of the case 112.

A linear vibrator 100 described in CN 103378703A includes a fixing adjustment portion 160 arranged to fix an elastic member 150 at a predetermined position in a fixed portion 110. The fixing adjustment portion 160 includes holes 162 defined in an upper surface of a case 112, and recessed portions 164 defined in the elastic member 150. When the elastic member 150 is fixed to the case 112, guide pins P are inserted through the holes 162 and the recessed portions 164 in a situation in which the holes 162 and the recessed portions 164 are in alignment with each other. Then, the elastic member 150 is fixed to the case 112 through welding.

In manufacture of the linear vibrator described in JP-A 2013-85438, it is necessary to emit the laser beams for welding into the case 112 through the holes 116 defined in the case 112 after the elastic member 140 and the holder 136 are brought into a proper positional relationship with the holes 116 defined in the upper surface of the case 112. Therefore, the manufacture of the linear vibrator is complicated. Meanwhile, in manufacture of the linear vibrator described in CN 103378703A, it is necessary to define the holes 162 for positioning in the upper surface of the case 112, and the guide pins P, which are to be inserted through the holes 162, are also required. Therefore, the manufacture of the linear vibrator is complicated.

### SUMMARY OF THE INVENTION

A vibration motor according to a preferred embodiment of the present invention includes a base portion arranged to extend perpendicularly to a central axis extending in a vertical direction; a magnet portion fixed above the base portion; an annular vibrating portion including a coil portion arranged radially opposite to the magnet portion, and a mass portion arranged radially outside of the coil portion, the vibrating portion being arranged around the magnet portion to vibrate in the vertical direction; a cover portion in a shape of a covered cylinder, fixed to the base portion, and arranged to cover upper and lateral sides of the vibrating portion; and an annular elastic member arranged around the magnet portion between an inner surface of an upper portion of the cover portion and an upper portion of the vibrating portion, and joined to both the upper portion of the cover portion and the upper portion of the vibrating portion. An inner edge portion of the elastic member is arranged radially inward of an inner circumferential edge of the mass portion. The inner edge portion of the elastic member includes a positioning portion defined therein. An outer surface of the upper portion of the cover portion includes a joint portion indicating a position at which the cover portion and the elastic member are joined to each other.

According to the above preferred embodiment of the present invention, manufacture of the vibration motor can be simplified.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a plan view of a vibration motor according to a preferred embodiment of the present invention.

FIG. 2 is a side view of the vibration motor.

FIG. 3 is a vertical sectional view of the vibration motor.

FIG. 4 is an exploded side view of the vibration motor.

FIG. 5 is an exploded perspective view of the vibration motor.

FIG. 6 is an enlarged vertical sectional view of a portion of the vibration motor.

FIG. 7 is an enlarged vertical sectional view of a portion of the vibration motor.

FIG. 8 is a flowchart illustrating a procedure for manufacturing the vibration motor.

FIG. 9 is a sectional view illustrating a portion of the vibration motor in the process of being manufactured.

FIG. 10 is a perspective view illustrating a portion of the vibration motor in the process of being manufactured.

FIG. 11 is a plan view illustrating a portion of the vibration motor in the process of being manufactured.

FIG. 12 is a sectional view illustrating a portion of the vibration motor in the process of being manufactured.

FIG. 13 is a sectional view illustrating a portion of the vibration motor in the process of being manufactured.

### DETAILED DESCRIPTION OF THE PREFERRED EMBODIMENTS

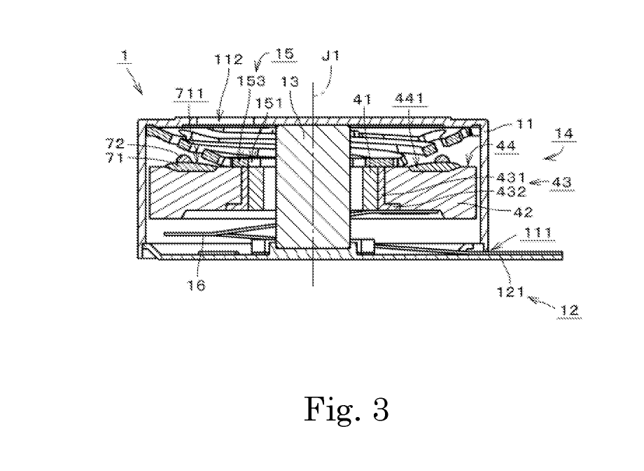

It is assumed herein that a vertical direction is defined as a direction in which a central axis J1 of a vibration motor 1 extends, and that an upper side and a lower side along the central axis J1 in FIG. 3 are referred to simply as an upper side and a lower side, respectively. It should be noted, however, that the above definitions of the vertical direction and the upper and lower sides are not meant to indicate relative positions or directions of different members or portions when those members or portions are actually installed in a device. Also note that a direction parallel to the central axis J1 is referred to by the term “vertical direction”, “vertical”, or “vertically”, that radial directions centered on the central axis J1 are simply referred to by the term “radial direction”, “radial”, or “radially”, and that a circumferential direction about the central axis J1 is simply referred to by the term “circumferential direction”, “circumferential”, or “circumferentially”.

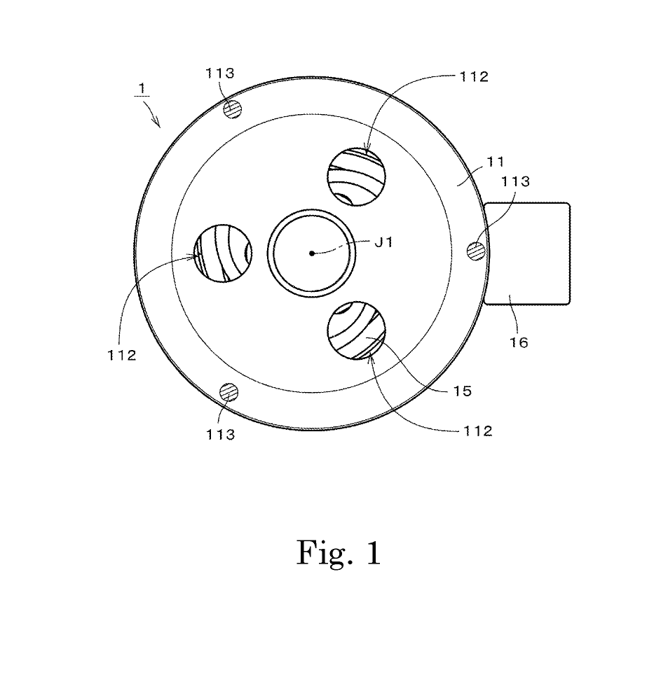

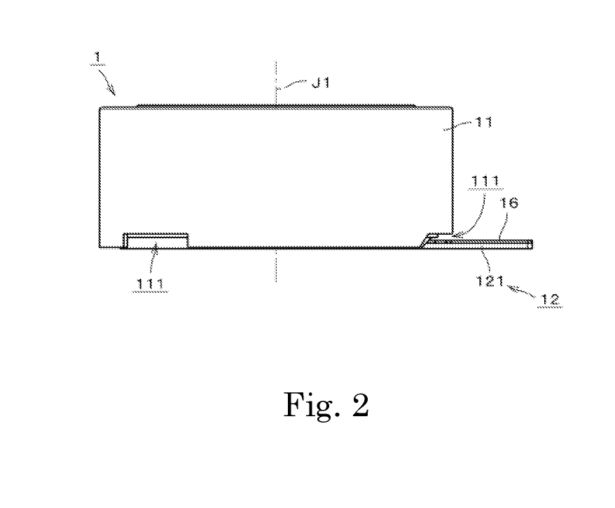

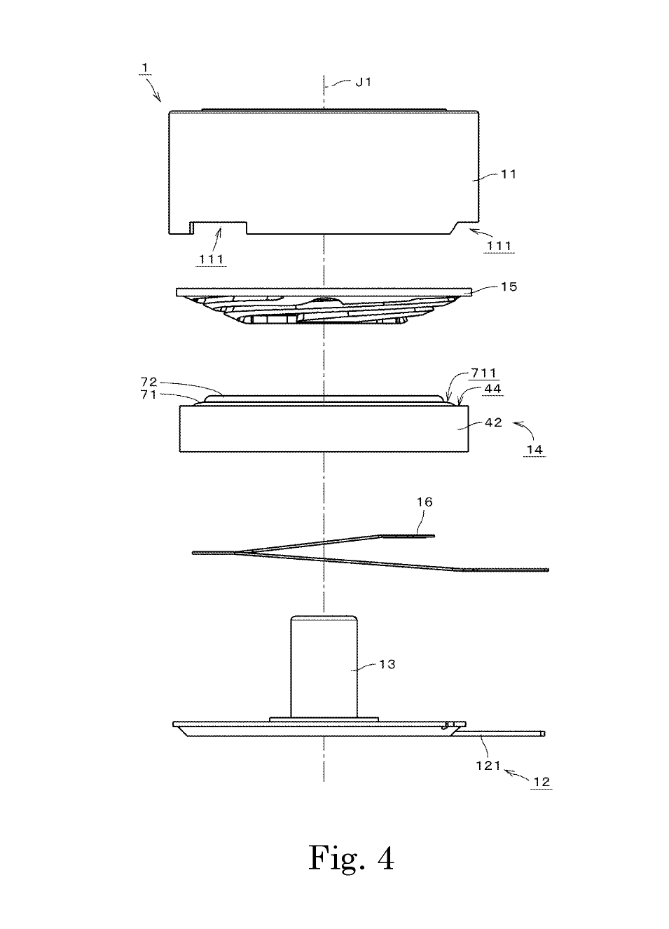

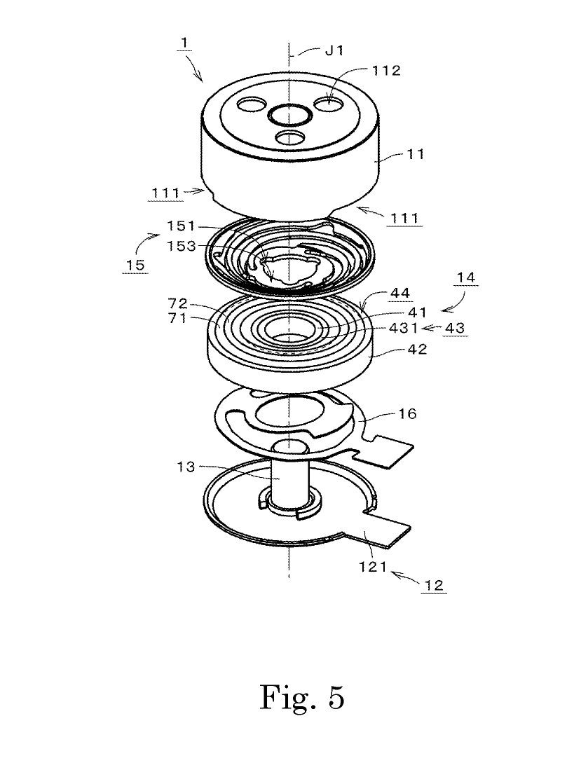

FIG. 1 is a plan view of the vibration motor 1 according to a preferred embodiment of the present invention. FIG. 2 is a side view of the vibration motor 1. FIG. 3 is a vertical sectional view of the vibration motor 1. FIG. 4 is an exploded side view of the vibration motor 1. FIG. 5 is an exploded perspective view of the vibration motor 1. Parallel oblique lines are omitted for sections of details in FIG. 3. In FIG. 3, a state in which a vibrating portion 14 described below is stationary, without vibrating in the vertical direction, is illustrated. The position of the vibrating portion 14 in FIG. 3 will be hereinafter referred to as a “stationary position”.

The vibration motor 1 is a linear resonant actuator (LRA). The vibration motor 1 is used in, for example, a silent notification device in a mobile communication apparatus, such as a cellular phone. In other words, the vibration motor 1 is included in the silent notification device, for example.

The vibration motor 1 includes a cover portion 11 and a base portion 12. The cover portion 11 is substantially in the shape of a covered cylinder. A top cover portion of the cover portion 11, which defines an upper portion of the cover portion 11, includes hole portions 112 defined therein. Each hole portion 112 is, for example, a through hole passing through the top cover portion. The number of hole portions 112 defined in the top cover portion may be one or more than one. In the preferred embodiment illustrated in FIG. 1, three hole portions 112 are arranged at substantially equal angular intervals with the central axis J1 as a center.

The base portion 12 is arranged to extend perpendicularly to the central axis J1, which extends in the vertical direction. The cover portion 11 is fixed to the base portion 12. The base portion 12 is arranged to close a lower opening of the cover portion 11. Each of the cover portion 11 and the base portion 12 is made of, for example, a metal. The cover portion 11 and the base portion 12 are joined to each other through, for example welding. The base portion 12 may not necessarily be exactly perpendicular to the central axis J1, but may extend substantially perpendicularly to the central axis J1. In other words, the base portion 12 is arranged to extend perpendicularly or substantially perpendicularly to the central axis J1.

The base portion 12 includes a base projecting portion 121 arranged to extend substantially perpendicularly to the central axis J1. The base projecting portion 121 is arranged to project radially outward from the cover portion 11. A plurality of cuts 111 each of which extends in a circumferential direction are defined at a lower edge of the cover portion 11. The base projecting portion 121, which is a portion of the base portion 12, is arranged to project radially outward from one of the cuts 111. In other words, a radially inner end portion of the base projecting portion 121 is arranged in one of the cuts 111. The plurality of cuts 111 defined in the cover portion 11 make it easy to align the base projecting portion 121 with one of the cuts 111 when fixing the base portion 12 to the cover portion 11.

The vibration motor 1 includes a magnet portion 13, the vibrating portion 14, an elastic member 15, a circuit board 16, an adhesive layer 71, and a viscous body 72. The magnet portion 13 is a substantially columnar member centered on the central axis J1. The magnet portion 13 is defined by a single monolithic member. The magnet portion 13 is fixed above the base portion 12, and is arranged to point in the vertical direction. For example, a lower end portion of the magnet portion 13 is fixed to an upper surface, i.e., an inner surface, of the base portion 12 through an adhesive or the like. Alternatively, an upper end portion of the magnet portion 13 may be fixed to a lower surface of the top cover portion of the cover portion 11, i.e., an inner surface of the upper portion of the cover portion 11, through an adhesive or the like.

The vibrating portion 14 is an annular member. The vibrating portion 14 is, for example, substantially cylindrical, and is centered on the central axis J1. The vibrating portion 14 is arranged to extend all the way around the magnet portion 13. The vibrating portion 14 is arranged to have an inside diameter greater than the outside diameter of the magnet portion 13. The vibrating portion 14 is arranged to vibrate in the vertical direction along the magnet portion 13 without making contact with the magnet portion 13. Upper and lateral sides of the magnet portion 13 and the vibrating portion 14 are covered with the cover portion 11.

The vibrating portion 14 includes a coil portion 41, a mass portion 42, and a yoke 43. The coil portion 41 is a substantially cylindrical member centered on the central axis J1. The coil portion 41 is arranged radially opposite to the magnet portion 13. An inner circumferential surface of the coil portion 41 is arranged radially opposite to an outer circumferential surface of the magnet portion 13 with a predetermined gap therebetween.

The yoke 43 includes a cylindrical portion 431 and a flange portion 432. The cylindrical portion 431 is substantially cylindrical, and is centered on the central axis J1. The flange portion 432 is substantially in the shape of a circular ring, and is centered on the central axis J1. The flange portion 432 is arranged to extend radially outward from a lower end portion of the cylindrical portion 431. The cylindrical portion 431 and the flange portion 432 are defined by a single continuous monolithic member. The yoke 43 is arranged radially outside of the coil portion 41. More specifically, the cylindrical portion 431 of the yoke 43 is arranged radially outside of the coil portion 41. An inner circumferential surface of the cylindrical portion 431 is fixed to an outer circumferential surface of the coil portion 41. The cylindrical portion 431 is fixed to the coil portion 41 through an adhesive, for example. The flange portion 432 may alternatively be arranged to extend radially outward from an upper end portion of the cylindrical portion 431, for example, or may not be provided.

The mass portion 42 is a substantially cylindrical member centered on the central axis J1. The mass portion 42 is a so-called weight. The mass portion 42 is arranged radially outside of the cylindrical portion 431 of the yoke 43 and the coil portion 41. In other words, the cylindrical portion 431 of the yoke 43 and the coil portion 41 are arranged radially inside of the mass portion 42. A central opening is defined in a central portion of the mass portion 42. An inner circumferential surface of the mass portion 42 is fixed to an outer circumferential surface of the cylindrical portion 431 of the yoke 43. An upper surface of the flange portion 432 of the yoke 43 is arranged to be in contact with a lower surface of the mass portion 42. The mass portion 42 is fixed to the yoke 43 through, for example, an adhesive or a double-sided tape, or through press fitting. The mass portion 42 is indirectly fixed to the coil portion 41 with the yoke 43 therebetween.

The elastic member 15 is arranged around the magnet portion 13 between the inner surface of the upper portion of the cover portion 11 and the upper portion of the vibrating portion 14. The elastic member 15 is an annular member capable of elastically deforming in the vertical direction through application of a vertical force. The elastic member 15 is, for example, defined by a plate-shaped spring material wound in a spiral shape, and includes a central opening defined in a central portion thereof. The elastic member 15 is, for example, defined by a volute spring the external shape of which is substantially a truncated cone. The elastic member 15 is arranged to extend radially inward and downward from the inner surface of the upper portion of the cover portion 11. In other words, the elastic member 15 has an external shape projecting downward with decreasing distance from the central axis J1.

An upper end portion of the elastic member 15 is joined to the upper portion of the cover portion 11. The upper end portion of the elastic member 15 is fixed to the lower surface of the top cover portion of the cover portion 11, i.e., the inner surface of the upper portion of the cover portion 11, through, for example, welding. An outer surface of the upper portion of the cover portion 11 includes joint portions 113 indicating positions at which the cover portion 11 and the elastic member 15 are joined to each other. In FIG. 1, each joint portion 113 is hatched with parallel oblique lines. The joint portions 113 are arranged in the vicinity of an outer circumferential edge of the outer surface of the upper portion of the cover portion 11. In the preferred embodiment illustrated in FIG. 1, the cover portion 11 and the elastic member 15 are joined to each other at three joint portions 113. In the case where the elastic member 15 and the cover portion 11 are joined to each other through welding, each joint portion 113 is a welding mark. A lower end portion of the elastic member 15 is joined to the upper portion of the vibrating portion 14. The lower end portion of the elastic member 15 is fixed to an upper surface of the mass portion 42 through welding, for example.

The adhesive layer 71 is fixed to an upper surface 44 of the vibrating portion 14. The adhesive layer 71 is arranged to extend in the circumferential direction below the elastic member 15. In other words, the adhesive layer 71 is arranged vertically opposite to the elastic member 15. In the preferred embodiment illustrated in FIGS. 3 to 5, the adhesive layer 71 is annular. The adhesive layer 71 is arranged on an annular recessed portion 441 defined in the upper surface 44 of the vibrating portion 14. Each of the adhesive layer 71 and the recessed portion 441 is, for example, substantially in the shape of a circular ring, and is centered on the central axis J1. The recessed portion 441 is defined in, for example, the upper surface of the mass portion 42.

In the preferred embodiment illustrated in FIGS. 3 to 5, an upper portion of the adhesive layer 71 is arranged at a level higher than the level of a portion of the upper surface 44 of the vibrating portion 14 which surrounds the recessed portion 441. An upper surface 711 of the adhesive layer 71 is entirely arranged at a level higher than the level of a portion of the upper surface 44 of the vibrating portion 14 which surrounds the adhesive layer 71, for example. The upper surface 711 of the adhesive layer 71 is arranged to be convex upward over the entire radial extent thereof. In addition, the upper surface 711 of the adhesive layer 71 is arranged to have a substantially identical shape over 360 degrees in the circumferential direction. The upper surface 711 of the adhesive layer 71 may be convex upward practically over the entire radial extent thereof. In other words, the upper surface 711 of the adhesive layer 71 is arranged to be convex upward over substantially the entire radial extent thereof. The upper surface 711 of the adhesive layer 71 is arranged to have a curvature continuously varying in a radial direction. For example, the curvature of the upper surface 711 of the adhesive layer 71 gradually decreases radially outward from a radially inner end of the upper surface 711 to an upper end of the upper surface 711, and gradually increases radially outward from the upper end of the upper surface 711 to a radially outer end of the upper surface 711.

The adhesive layer 71 is defined by, for example, applying an adhesive in an uncured state to the recessed portion 441 in such a manner that the adhesive will rise above the upper surface 44 of the vibrating portion 14 inside the recessed portion 441, and curing the adhesive. The adhesive layer 71 is defined by, for example, applying the adhesive to the vibrating portion 14 only once.

The viscous body 72 is in a paste, having viscosity. The viscous body 72 is, for example, grease. Note that the viscous body 72 may be a material other than grease as long as the material is in a paste having viscosity. The viscous body 72 is arranged to extend in the circumferential direction on the upper surface 711 of the adhesive layer 71. The viscous body 72 has a relatively high viscosity, so high as to maintain the shape of the viscous body 72 on the adhesive layer 71 when no external force is applied to the viscous body 72. In the preferred embodiment illustrated in FIGS. 3 to 5, the viscous body 72 is annular. The viscous body 72 is, for example, substantially in the shape of a circular ring, and is centered on the central axis J1.

The viscous body 72 is arranged below the elastic member 15. In other words, the viscous body 72 is arranged vertically opposite to the elastic member 15. An upper end portion of the viscous body 72 is arranged at a level higher than the level of the upper surface 44 of the vibrating portion 14. In the preferred embodiment illustrated in FIGS. 3 to 5, the viscous body 72 is arranged on an upper end portion of the upper surface 711 of the adhesive layer 71.

The circuit board 16 is arranged to supply an electric current from a power source to the coil portion 41. The circuit board 16 is a flexible substrate including a flexible printed circuit (FPC). The circuit board 16 is relatively thin and soft. The circuit board 16 is arranged between the base portion 12 and the vibrating portion 14, and is joined to an upper portion of the base portion 12 and a lower portion of the vibrating portion 14. The circuit board 16 is fixed to each of the base portion 12 and the vibrating portion 14 through, for example, an adhesive.

In the vibration motor 1, once the electric current is passed in the coil portion 41 through the circuit board 16, a magnetic field is generated around the coil portion 41 and the yoke 43. This magnetic field and a magnetic field around the magnet portion 13 together generate forces that cause the vibrating portion 14 to move in the vertical direction. The vibrating portion 14 is supported by the elastic member 15 in the vertical direction, and accordingly vibrates in the vertical direction through forces received from the magnetic fields and resilience of the elastic member 15.

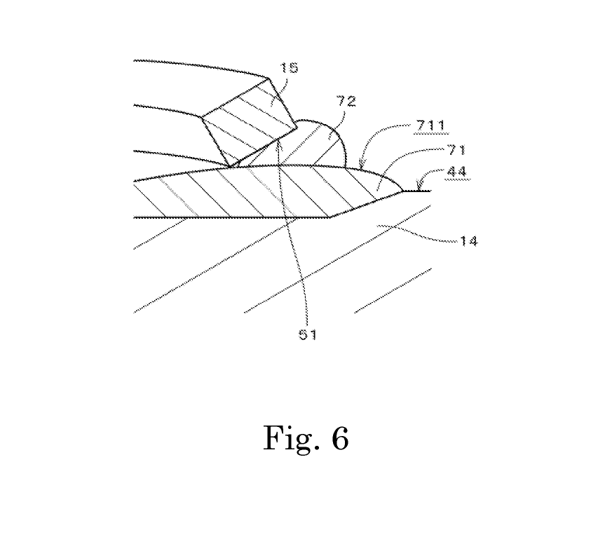

When the vibrating portion 14 vibrates in the vertical direction, the elastic member 15 expands and contracts in the vertical direction. When the vibrating portion 14 moves upward above the stationary position to compress the elastic member 15, the vertical distance between the upper surface 44 of the vibrating portion 14 and a lower surface of the elastic member 15 is reduced at a radial position where the adhesive layer 71 is provided as illustrated in FIG. 6. This causes the elastic member 15 to make contact with the viscous body 72 on the adhesive layer 71. The viscous body 72 on the adhesive layer 71 is deformed as a result of a contact with the elastic member 15. In addition, the elastic member 15 makes contact with the upper surface 711 of the adhesive layer 71 as well.

Specifically, the elastic member 15 includes a “viscous body opposed portion” 51 arranged vertically opposite to the viscous body 72, and a radially inner portion of the viscous body opposed portion 51 makes contact with the upper surface 711 of the adhesive layer 71. As a result, a gap is maintained between the elastic member 15 and the upper surface 711 of the adhesive layer 71 over a region radially outside of an area of contact between the viscous body opposed portion 51 and the adhesive layer 71. This allows the viscous body 72 to be held in the gap without being scattered radially outward by being compressed by the elastic member 15.

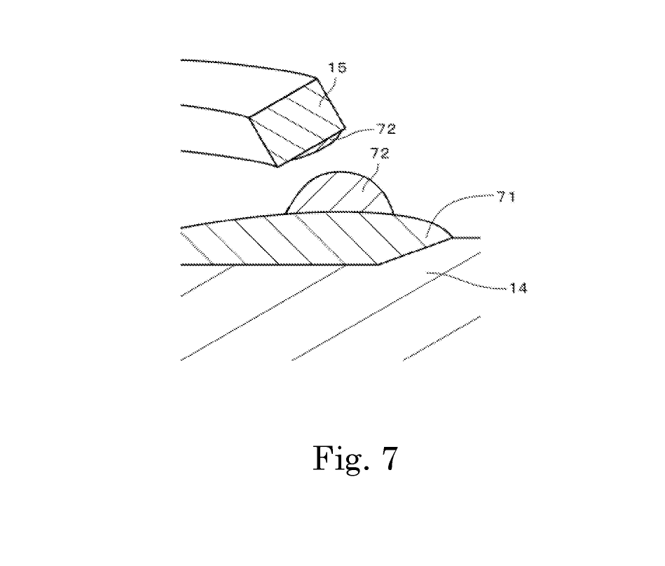

As illustrated in FIG. 7, when the vibrating portion 14 moves downward thereafter, a portion of the viscous body 72 on the adhesive layer 71 sticks to the elastic member 15, and separates upward from the viscous body 72 on the adhesive layer 71 together with the elastic member 15. In the vibration motor 1, as the vertical movement of the vibrating portion 14 is repeated, portions of the viscous body 72 on the adhesive layer 71 move to the elastic member 15 one after another. In other words, as the vibrating portion 14 vibrates, portions of the viscous body 72 are intermittently supplied from the vibrating portion 14 to the elastic member 15.

In the vibration motor 1, a portion of the viscous body 72 sticks to the elastic member 15 when the elastic member 15 approaches and makes indirect contact with the vibrating portion 14. Accordingly, vibration at an unwanted frequency component that is caused in the elastic member 15 by the indirect contact of the elastic member 15 with the vibrating portion 14, e.g., vibration at a frequency component other than a natural vibration frequency, is absorbed by elastic action of the viscous body 72. In other words, the sticking of a portion of the viscous body 72 to the elastic member 15 reduces variations in vibration frequency components of the elastic member 15 caused by the indirect contact of the elastic member 15 with the vibrating portion 14, leading to stabilizing the vibration frequency of the elastic member 15. This allows the vibrating portion 14 to vibrate at a desired vibration frequency to increase the amount of vibration of the vibration motor 1. The desired vibration frequency is, for example, a natural vibration frequency of the elastic member 15. Note that, although the sticking of portions of the viscous body 72 to the elastic member 15 also reduces vibration at the above desired frequency component to some degree, the reduction of the vibration at the unwanted frequency component results in a greater proportion of the desired frequency component in all frequency components. This leads to an increased amount of vibration of the vibration motor 1 as mentioned above.

In addition, in the vibration motor 1, when the elastic member 15 is compressed, the elastic member 15 makes contact with the adhesive layer 71, and this prevents or reduces the likelihood of a direct contact between the elastic member 15 and the vibrating portion 14. This contributes to preventing noise caused by a collision between the elastic member 15 and the vibrating portion 14. Moreover, compared to the case where a damper separate from the vibrating portion 14 is fitted onto the vibrating portion 14 to prevent a direct contact between the elastic member 15 and the vibrating portion 14, a reduction in the number of parts of the vibration motor 1 and a reduction in the number of steps for assembling the vibration motor 1 are achieved. This contributes to preventing or reducing an increase in the production cost of the vibration motor 1.

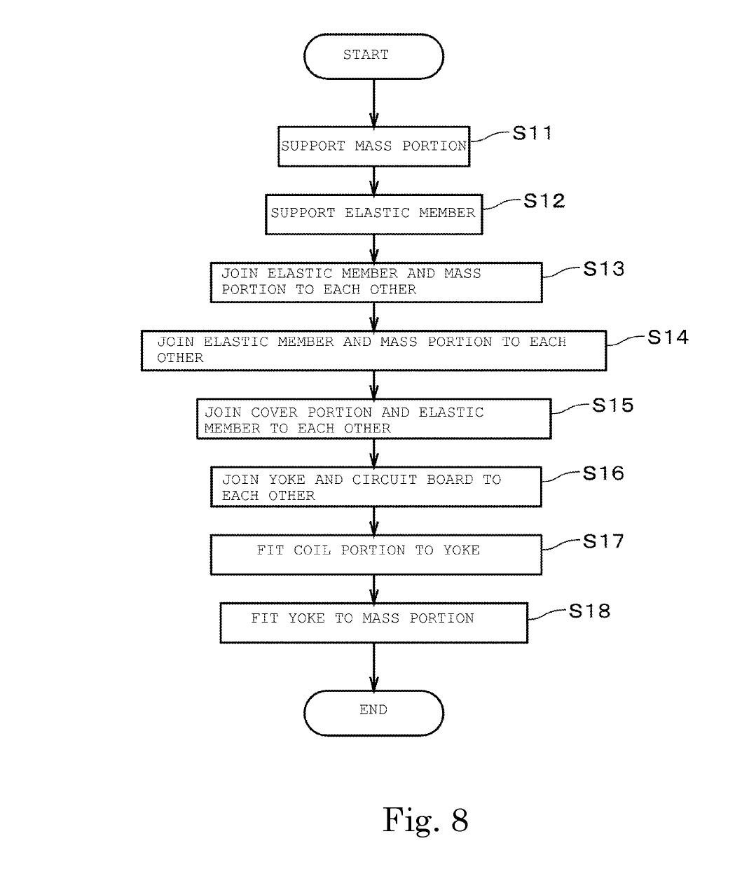

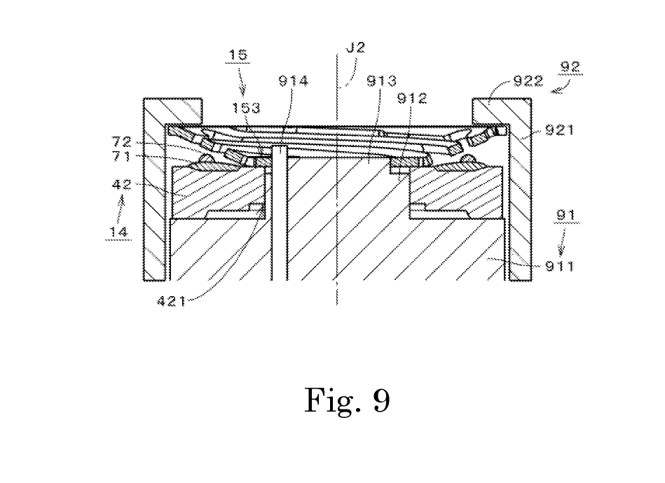

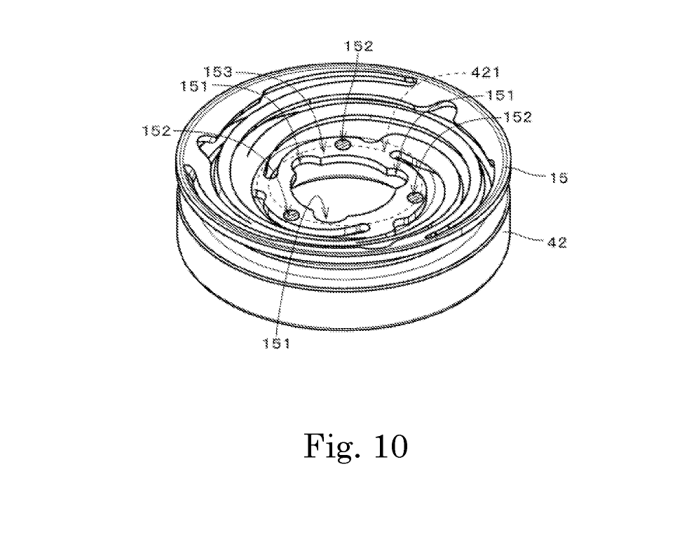

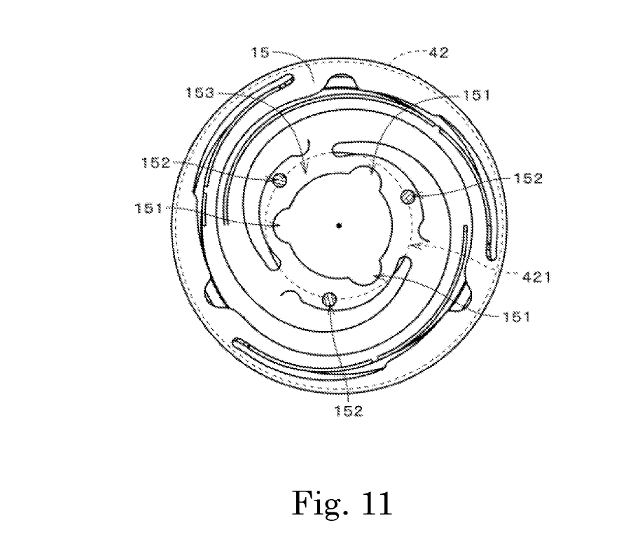

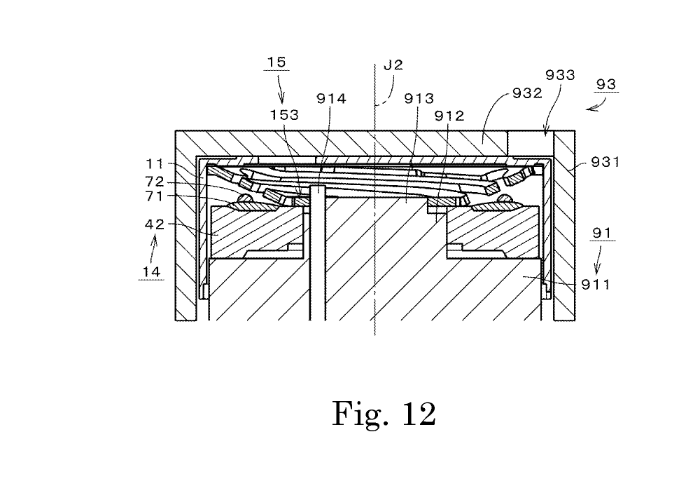

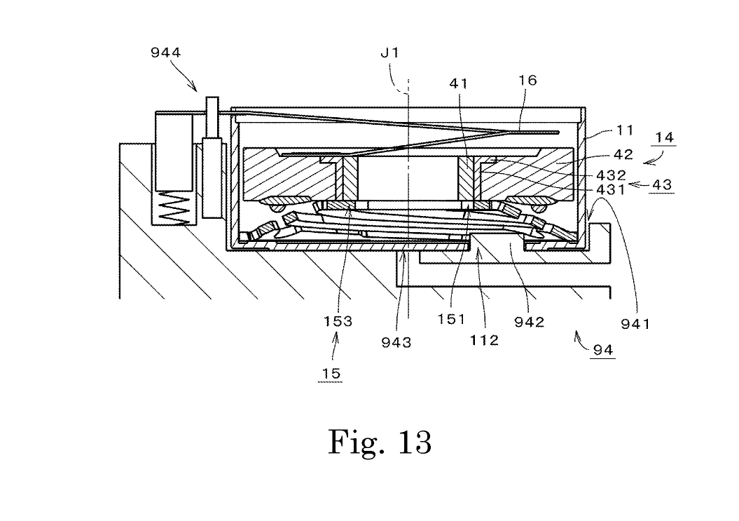

Next, a method of manufacturing the vibration motor 1 will now be described below. FIG. 8 is a flowchart illustrating a procedure for manufacturing the vibration motor 1. FIG. 9 is a sectional view illustrating a portion of the vibration motor 1 in the process of being manufactured. In FIG. 9, a supporting jig 91 and a first holding jig 92, each of which is a jig used in manufacture of the vibration motor 1, are also shown. FIG. 10 is a perspective view illustrating a portion of the vibration motor 1 in the process of being manufactured. FIG. 11 is a plan view illustrating a portion of the vibration motor 1 in the process of being manufactured. FIG. 12 is a sectional view illustrating a portion of the vibration motor 1 in the process of being manufactured. In FIG. 12, the supporting jig 91 and a second holding jig 93, each of which is a jig used in the manufacture of the vibration motor 1, are also shown. FIG. 13 is a sectional view illustrating a portion of the vibration motor 1 in the process of being manufactured. In FIG. 13, a holding device 94, which is a jig used in the manufacture of the vibration motor 1, is also shown.

The supporting jig 91 includes a supporting base portion 911, a first projecting portion 912, a second projecting portion 913, and a positioning pin 914. The supporting base portion 911 is substantially columnar, and is centered on a central axis J2 of the supporting jig 91, which extends in the vertical direction. The first projecting portion 912 is a columnar portion arranged to project upward from a central portion of an upper surface of the supporting base portion 911. The first projecting portion 912 is substantially columnar, and is centered on the central axis J2. The first projecting portion 912 is arranged to have a diameter smaller than a diameter of the supporting base portion 911. The second projecting portion 913 is a columnar portion arranged to project upward from a central portion of an upper surface of the first projecting portion 912. The second projecting portion 913 is substantially columnar, and is centered on the central axis J2. The second projecting portion 913 is arranged to have a diameter smaller than the diameter of the first projecting portion 912.

The upper surface of the supporting base portion 911 is a substantially annular surface arranged to surround the first projecting portion 912 in a plan view. The upper surface of the first projecting portion 912 is a substantially annular surface arranged to surround the second projecting portion 913 in the plan view. The positioning pin 914 is arranged to project upward from the upper surface of the first projecting portion 912. The positioning pin 914 is substantially columnar. A radially inner portion of the positioning pin 914 is arranged radially inward of an outer circumferential edge of the second projecting portion 913 in the plan view. A radially outer portion of the positioning pin 914 is arranged radially outward of the outer circumferential edge of the second projecting portion 913 in the plan view. In other words, the radially outer portion of the positioning pin 914 defines a protruding portion arranged to project radially outward from an outer circumferential surface of the second projecting portion 913. The entire positioning pin 914 is arranged radially inward of an outer circumferential edge of the first projecting portion 912 in the plan view.

The number of positioning pins 914 included in the supporting jig 91 may be either only one or more than one. In the case where the supporting jig 91 includes a plurality of positioning pins 914, the positioning pins 914 are arranged at substantially equal angular intervals in a circumferential direction about the central axis J2, for example.

The first holding jig 92 is a substantially cylindrical member. The first holding jig 92 includes a side wall portion 921 and an upper surface portion 922. The side wall portion 921 is substantially cylindrical, and is centered on the central axis J2. The upper surface portion 922 is substantially in the shape of an annular plate, and is centered on the central axis J2. The upper surface portion 922 is arranged to extend radially inward from an upper end portion of the side wall portion 921. The side wall portion 921 is arranged to have an inside diameter greater than both an outside diameter of the mass portion 42 and an outside diameter of the elastic member 15. The upper surface portion 922 is arranged to have an inside diameter smaller than an outside diameter of the upper end portion of the elastic member 15.

The second holding jig 93 is substantially in the shape of a covered cylinder. The second holding jig 93 includes a side wall portion 931 and an upper surface portion 932. The side wall portion 931 is substantially cylindrical, and is centered on the central axis J2. The upper surface portion 932 is substantially disk-shaped, and is centered on the central axis J2. An outer edge portion of the upper surface portion 932 is joined to an upper end portion of the side wall portion 931. The side wall portion 931 is arranged to have an inside diameter greater than an outside diameter of the cover portion 11. A plurality of through holes 933 are defined in an outer circumferential portion of the upper surface portion 932. For example, three through holes 933 are arranged at substantially equal angular intervals in the circumferential direction about the central axis J2. In FIG. 12, only one of the through holes 933 is shown.

The holding device 94 includes a recessed holding portion 941 arranged to hold the cover portion 11. The recessed holding portion 941 is substantially columnar. The recessed holding portion 941 is arranged to have an inside diameter greater than the outside diameter of the cover portion 11. In the recessed holding portion 941, the top cover portion and an adjacent portion of the cover portion 11, with the cover portion 11 turned upside down, are arranged. An opening 943 of a suction channel connected to a suction mechanism (not shown) is defined in a substantially central portion of a bottom surface of the recessed holding portion 941. The suction mechanism is driven to cause the top cover portion of the cover portion 11 to be attached to the bottom surface of the recessed holding portion 941 by suction. A protruding positioning portion 942 is defined in the bottom surface of the recessed holding portion 941. The number of protruding positioning portions 942 may be either only one or more than one. Note, however, that the number of protruding positioning portions 942 should be equal to or smaller than the number of hole portions 112 of the cover portion 11 described above. The holding device 94 further includes a board support portion 944 arranged to support the circuit board 16.

When the vibration motor 1 is manufactured, first, the adhesive layer 71 is formed on the upper surface of the mass portion 42, and the viscous body 72 is arranged on the adhesive layer 71. Next, the mass portion 42 is supported by the supporting jig 91 as illustrated in FIG. 9 (step S11). More specifically, the first and second projecting portions 912 and 913 of the supporting jig 91 are inserted into the central opening of the substantially cylindrical mass portion 42 from below. The lower surface of the mass portion 42 is arranged to be in contact with the upper surface of the supporting base portion 911. The mass portion 42 is thus supported by the supporting jig 91 from below. An outer circumferential surface of the first projecting portion 912 is arranged to be in contact with the inner circumferential surface of the mass portion 42. The horizontal position of the mass portion 42 is thus fixed. Each of the outer circumferential surface of the second projecting portion 913 and the positioning pin 914 is spaced radially inward from the inner circumferential surface of the mass portion 42. Note that the formation of the adhesive layer 71 and the arrangement of the viscous body 72 may alternatively be carried out after the mass portion 42 is supported by the supporting jig 91.

Next, the elastic member 15 is supported by the supporting jig 91 on the upper side of the mass portion 42 (step S12). More specifically, the second projecting portion 913 of the supporting jig 91 is inserted into the central opening of the elastic member 15 from below. An inner edge portion 153 of the elastic member 15, i.e., the inner edge portion 153 of the lower end portion of the elastic member 15, is arranged radially inward of an inner circumferential edge 421 of the mass portion 42. Positioning portions 151 are defined in the inner edge portion 153 of the elastic member 15. Each positioning portion 151 is, for example, a recessed portion recessed radially outward from an inner circumferential edge of the elastic member 15. The positioning pin 914 is inserted into the positioning portion 151 from below when the second projecting portion 913 of the supporting jig 91 is inserted into the central opening of the elastic member 15. The positioning portion 151 and the radially outer portion of the positioning pin 914 are circumferentially engaged with each other to fix the circumferential orientation of the elastic member 15.

After the elastic member 15 is supported by the supporting jig 91, the first holding jig 92 is placed on the elastic member 15 from the upper side of the elastic member 15. The upper surface portion 922 of the first holding jig 92 is arranged to make contact with an outer edge portion of the upper end portion of the elastic member 15 from the upper side thereof. Then, the first holding jig 92 is pressed downward to compress the elastic member 15 in the vertical direction, so that the lower end portion of the elastic member 15 is pressed against the upper surface of the mass portion 42.

In this situation, the elastic member 15 and an upper portion of the mass portion 42 are joined to each other (step S13). More specifically, the lower end portion of the elastic member 15 and the upper portion of the mass portion 42 are joined to each other through, for example, welding at first joint positions in a circumferential direction of the elastic member 15. The circumferential positions of the first joint positions are different from the circumferential positions of the positioning portions 151. Note that the elastic member 15 and the mass portion 42 may alternatively be joined to each other by a method other than welding.

Joint portions 152 indicating positions at which the elastic member 15 and the mass portion 42 are joined to each other are defined in an upper surface of the lower end portion of the elastic member 15, i.e., an upper surface of an inner circumferential portion of the elastic member 15. In each of FIGS. 10 and 11, each joint portion 152 is hatched with parallel oblique lines. In the preferred embodiment illustrated in FIGS. 10 and 11, the elastic member 15 and the mass portion 42 are joined to each other at three joint portions 152. In the case where the elastic member 15 and the mass portion 42 are joined to each other through welding, each joint portion 152 is a welding mark. The welding of the elastic member 15 and the mass portion 42 is carried out, for example, in a situation in which a welding machine is inserted through an opening of the upper surface portion 922 of the first holding jig 92 from above.

After step S13, the first holding jig 92 is removed. Next, as illustrated in FIG. 12, the mass portion 42 and the elastic member 15, which are supported by the supporting jig 91, are covered with the cover portion 11 from the upper side. The upper and lateral sides of the mass portion 42 and the elastic member 15 are thus covered with the cover portion 11 (step S14).

Further, the cover portion 11 is covered with the second holding jig 93 from the upper side. The circumferential position of the second holding jig 93 relative to the supporting jig 91 is fixed. The upper surface portion 932 of the second holding jig 93 is arranged to make contact with an upper surface of the cover portion 11 from the upper side thereof. Then, the second holding jig 93 is pressed downward to compress the elastic member 15 in the vertical direction, so that the upper end portion of the elastic member 15 is pressed against the inner surface of the upper portion of the cover portion 11.

In this situation, the upper portion of the cover portion 11 and the elastic member 15 are joined to each other (step S15). More specifically, at second joint positions in the circumferential direction of the elastic member 15, the upper end portion of the elastic member 15 and the top cover portion of the cover portion 11, which is the upper portion of the cover portion 11, are joined to each other through, for example, welding from above the outer surface of the upper portion of the cover portion 11. The welding of the elastic member 15 and the cover portion 11 is carried out through the through holes 933 of the second holding jig 93. That is, the circumferential positions the through holes 933 of the second holding jig 93 correspond to the aforementioned second joint positions. The second joint positions may be arranged at either the same or different circumferential positions as those of the aforementioned first joint positions.

The circumferential orientation of the second holding jig 93 relative to the supporting jig 91 is fixed. Thus, the through holes 933 are positioned over predetermined positions in the elastic member 15 at which the cover portion 11 is joined to the elastic member 15. Note that, because the elastic member 15 may be joined to the cover portion 11 at any circumferential positions in the cover portion 11, circumferential positioning of the cover portion 11 is not necessary.

As noted above, the outer surface of the upper portion of the cover portion 11 includes the three joint portions 113, which indicate the positions at which the cover portion 11 and the elastic member 15 are joined to each other. Note that the cover portion 11 and the elastic member 15 may alternatively be joined to each other by a method other than welding. After step S15, the second holding jig 93 is removed. Moreover, the cover portion 11, the elastic member 15, and the mass portion 42 joined to one another are removed from the supporting jig 91.

Next, a lower portion of the yoke 43 and an upper portion of the circuit board 16 are joined to each other as illustrated in FIG. 3 (step S16). More specifically, an upper surface of the upper portion of the circuit board 16 is pressed against and thus joined to a lower surface of the flange portion 432 of the yoke 43 with, for example, an adhesive therebetween. In addition, after step S16, the coil portion 41 is inserted into a space radially inside of the cylindrical portion 431 of the yoke 43 from below, i.e., from the far side of the flange portion 432, and is fitted to the yoke 43 (step S17). Then, lead wires extending from the coil portion 41 are electrically connected to a lower surface of the upper portion of the circuit board 16 through, for example, solders. Note that steps S16 and S17 may alternatively be performed before or in parallel with steps S11 to S15.

Meanwhile, as illustrated in FIG. 13, the cover portion 11, the elastic member 15, and the mass portion 42, which have been removed from the supporting jig 91, are arranged inside the recessed holding portion 941 of the holding device 94, with the top cover portion of the cover portion 11 facing downward. The top cover portion of the cover portion 11 is attached to the bottom surface of the recessed holding portion 941 by suction. The protruding positioning portion 942 of the holding device 94 is inserted through one of the hole portions 112 of the cover portion 11. The hole portion 112 and the protruding positioning portion 942 are engaged with each other to fix the circumferential orientation of the cover portion 11, the elastic member 15, and the mass portion 42.

After the above-described steps S11 to S17, the cylindrical portion 431 of the yoke 43, with the coil portion 41 fitted thereto as a result of step S17, is inserted into a space radially inside of the mass portion 42 held by the holding device 94 from the lower side of the vibration motor 1, i.e., from an opposite side of the mass portion 42 with respect to the elastic member 15, and is fitted to the mass portion 42 (step S18). At this time, the flange portion 432 of the yoke 43 makes contact with the lower surface of the mass portion 42 to determine the vertical position of the yoke 43 relative to the mass portion 42. In step S18, the protruding positioning portion 942 of the holding device 94 is in engagement with the hole portion 112 of the cover portion 11 as described above, whereby the circumferential orientation of the cover portion 11 is fixed. This facilitates circumferential positioning of the yoke 43, the coil portion 41, and the circuit board 16 with respect to the cover portion 11, the elastic member 15, and the mass portion 42.

Referring to FIG. 13, the coil portion 41 and the elastic member 15 are arranged one above the other in the vertical direction. In other words, at least a portion of the coil portion 41 and at least a portion of the elastic member 15 are arranged to overlap with each other when viewed in the vertical direction. More specifically, an outer circumferential portion of the coil portion 41 is arranged under the inner edge portion 153 of the elastic member 15 in the vertical direction. Thus arranging the coil portion 41 and the elastic member 15 one above the other in the vertical direction contributes to preventing the coil portion 41 from being displaced in the vertical direction on the radially inner side of the yoke 43 and moving upward in the vibration motor 1 relative to the elastic member 15, that is, from moving toward the upper portion of the cover portion 11, in step S18. In other words, the elastic member 15 serves as a stopper to prevent the coil portion 41 from coming off the yoke 43. This simplifies the manufacture of the vibration motor 1.

The fitting of the yoke 43 to the mass portion 42 at step S18 is carried out through, for example, an adhesive. More specifically, for example, with the adhesive applied on the inner circumferential surface of the mass portion 42, the cylindrical portion 431 of the yoke 43 is inserted from the lower side of the vibration motor 1, so that the inner circumferential surface of the mass portion 42 and the outer circumferential surface of the cylindrical portion 431 are joined to each other through the adhesive. In the case where the cylindrical portion 431 of the yoke 43 is fitted to a radially inner side of the mass portion 42 through the adhesive at step S18 as described above, an extra portion of the adhesive may be pressed upwardly out of a gap between the yoke 43 and the mass portion 42, that is, toward the elastic member 15, when the cylindrical portion 431 is inserted into the mass portion 42. In this case, the extra adhesive pressed out spreads radially inward along a lower surface of the inner edge portion 153 of the elastic member 15 in the vibration motor 1. A portion of the extra adhesive is arranged in each positioning portion 151, which is a recessed portion defined in the inner circumferential edge of the elastic member 15. That is, each positioning portion 151 serves as an adhesive reservoir to store a portion of the extra adhesive. This contributes to preventing the adhesive from spreading radially inward beyond the inner circumferential edge of the elastic member 15.

After step S18, the base portion 12 is joined to the cover portion 11 to close the lower opening of the cover portion 11 as illustrated in FIG. 3, whereby the manufacture of the vibration motor 1 is completed.

As described above, the vibration motor 1 includes the cover portion 11, which is in the shape of a covered cylinder, the base portion 12, the magnet portion 13, the vibrating portion 14, and the annular elastic member 15. The base portion 12 is arranged to extend perpendicularly to the central axis J1 extending in the vertical direction. The magnet portion 13 is fixed above the base portion 12. The vibrating portion 14 is arranged around the magnet portion 13 to vibrate in the vertical direction. The vibrating portion 14 includes the coil portion 41 and the mass portion 42. The coil portion 41 is arranged radially opposite to the magnet portion 13. The mass portion 42 is arranged radially outside of the coil portion 41. The cover portion 11 is arranged to cover the upper and lateral sides of the vibrating portion 14, and is fixed to the base portion 12. The elastic member 15 is arranged around the magnet portion 13 between the inner surface of the upper portion of the cover portion 11 and the upper portion of the vibrating portion 14. The elastic member 15 is joined to the upper portion of the cover portion 11 and the upper portion of the vibrating portion 14. The inner edge portion 153 of the elastic member 15 is arranged radially inward of the inner circumferential edge 421 of the mass portion 42. The inner edge portion 153 of the elastic member 15 includes the positioning portions 151 defined therein. The joint portions 113, which indicate the positions at which the cover portion 11 and the elastic member 15 are joined to each other, are defined in the outer surface of the upper portion of the cover portion 11.

When the vibration motor 1 is manufactured, the supporting jig 91 is inserted into the central opening of the mass portion 42, so that the mass portion 42 is supported by the supporting jig 91 (step S11). Then, the supporting jig 91 is inserted into the central opening of the elastic member 15. Then, at least one of the positioning portions 151 defined in the inner edge portion 153 of the elastic member 15 is circumferentially engaged with the supporting jig 91, so that the circumferential orientation of the elastic member 15 is fixed (step S12). Next, the elastic member 15 and the upper portion of the mass portion 42 are joined to each other at the first joint positions in the circumferential direction of the elastic member 15 (step S13). After step S13, the mass portion 42 and the elastic member 15, which are supported by the supporting jig 91, are covered with the cover portion 11 from the upper side, so that the upper and lateral sides of the mass portion 42 and the elastic member 15 are covered with the cover portion 11 (step S14). Thereafter, at the second joint positions in the circumferential direction of the elastic member 15, the elastic member 15 and the upper portion of the cover portion 11 are joined to each other through, for example, welding from above the outer surface of the upper portion of the cover portion 11 (step S15).

As described above, in the manufacture of the vibration motor 1, both the joining of the elastic member 15 and the mass portion 42 to each other and the joining of the elastic member 15 and the cover portion 11 to each other can be carried out in the situation in which the elastic member 15 and so on are fitted to the single supporting jig 91. Moreover, the positions at which the elastic member 15 and the cover portion 11 are joined to each other can be identified from the outer side of the cover portion 11 in the situation in which the elastic member 15 is covered with the cover portion 11. That is, the positions at which the elastic member 15 and the cover portion 11 are joined to each other can be identified without the need to view the inside of the cover portion 11. This makes it possible to simplify the joining of the elastic member 15 and the cover portion 11 to each other. This in turn makes it possible to simplify the manufacture of the vibration motor 1.

As described above, each positioning portion 151 of the vibration motor 1 is a recessed portion recessed radially outward. This enables the positioning of the elastic member 15 to be accomplished with a simple structure when the vibration motor 1 is manufactured.

Moreover, the vibration motor 1 further includes the flexible circuit board 16. The circuit board 16 is arranged between the base portion 12 and the vibrating portion 14, and is joined to both the upper portion of the base portion 12 and the lower portion of the vibrating portion 14. The vibrating portion 14 further includes the yoke 43. The yoke 43 includes the cylindrical portion 431, which is cylindrical and is arranged radially outside of the coil portion 41 and radially inside of the mass portion 42. When the vibration motor 1 is manufactured, the lower portion of the yoke 43 and the upper portion of the circuit board 16 are joined to each other (step S16). Then, after step S16, the coil portion 41 is inserted into the space radially inside of the cylindrical portion 431 of the yoke 43, and is thus fitted to the yoke 43 (step S17).

This reduces the likelihood that the coil portion 41 will be damaged by, for example, a portion thereof getting caught between the yoke 43 and the circuit board 16, when compared to the case where the yoke 43 is joined to the circuit board 16 after the coil portion 41 is inserted inside of the cylindrical portion 431 of the yoke 43. Note that, in the case where there is only a low probability that damage to the coil portion 41, such as, for example, a deformation or a wire break, will occur, the yoke 43 may be joined to the circuit board 16 after the coil portion 41 is inserted inside of the cylindrical portion 431 of the yoke 43.

Note that the vibration motor 1, the silent notification device, and the method of manufacturing the vibration motor 1 described above may be modified in various manners.

For example, the cylindrical portion 431 of the yoke 43 may alternatively be fitted to the radially inner side of the mass portion 42 by any desirable method other than adhesion using the adhesive. In the case where the adhesive is not used to fit the cylindrical portion 431 to the mass portion 42, for example, no adhesive may be arranged in any positioning portion 151, which is a recessed portion.

Also note that each positioning portion 151 of the elastic member 15 may not necessarily be a recessed portion recessed radially outward, but may alternatively be in any other desirable form. For example, each positioning portion 151 may alternatively be a through hole defined in the inner edge portion 153 of the elastic member 15, or a recessed portion recessed upward.

Also note that the coil portion 41 and the elastic member 15 may not necessarily be arranged one above the other in the vertical direction. For example, the inner circumferential edge of the elastic member 15 may alternatively be arranged radially outward of the outer circumferential surface of the coil portion 41.

In the vibration motor 1, the elastic member 15 may be in contact with the viscous body 72 on the adhesive layer 71 in a situation in which the vibrating portion 14 is located at the stationary position illustrated in FIG. 3. In this case, the area of contact between the elastic member 15 and the viscous body 72 on the adhesive layer 71 increases as the vibrating portion 14 moves upward above the stationary position. When the vibrating portion 14 moves downward thereafter, a portion of the viscous body 72 on the adhesive layer 71 sticks to the elastic member 15, and separates upward from the viscous body 72 on the adhesive layer 71 together with the elastic member 15. Note that each of the adhesive layer 71 and the viscous body 72 may be omitted in the vibration motor 1.

Also note that the external shape of the elastic member 15 may not necessarily be substantially a truncated cone, but may be modified in various manners. Also note that the elastic member 15 may not necessarily be defined by a plate-shaped spring material wound in a spiral shape, but may alternatively have any other desirable structure.

The magnet portion 13 may not necessarily be defined by a single monolithic member. The magnet portion 13 may alternatively include, for example, two substantially columnar magnets each of which points in the vertical direction, and a pole piece arranged between the two magnets. The plurality of cuts 111 may not necessarily be defined in the lower edge of the cover portion 11.

Fitting and fixing of the members of the vibration motor 1 may be achieved indirectly. For example, the elastic member 15 may be fixed to the cover portion 11 with another member intervening therebetween, the elastic member 15 and the vibrating portion 14 may be fixed to each other with another member intervening therebetween, and the cover portion 11 and the base portion 12 may be fixed to each other with another member intervening therebetween.

Note that features of the above-described preferred embodiments and the modifications thereof may be combined appropriately as long as no conflict arises.

Vibration motors according to preferred embodiments of the present invention may be used for various purposes. Vibration motors according to preferred embodiments of the present invention are preferably used as silent notification devices in, for example, mobile communication apparatuses, such as cellular phones, or electronic devices.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a base portion arranged to extend perpendicularly to a central axis extending in a vertical direction;
a magnet portion fixed above the base portion;
an annular vibrating portion including a coil portion arranged radially opposite to the magnet portion, and a mass portion arranged radially outside of the coil portion, the vibrating portion being arranged around the magnet portion to vibrate in the vertical direction;
a cover portion in a shape of a covered cylinder, fixed to the base portion, and arranged to cover upper and lateral sides of the vibrating portion; and
an annular elastic member arranged around the magnet portion between an inner surface of an upper portion of the cover portion and an upper portion of the vibrating portion, and joined to both the upper portion of the cover portion and the upper portion of the vibrating portion; wherein
an inner edge portion of the elastic member is arranged radially inward of an inner circumferential edge of the mass portion;
the inner edge portion of the elastic member includes a positioning portion defined therein; and
an outer surface of the upper portion of the cover portion includes a joint portion indicating a position at which the cover portion and the elastic member are joined to each other.

2. The vibration motor according to claim 1, wherein the positioning portion is a recessed portion recessed radially outward.

3. The vibration motor according to claim 2, wherein
the vibrating portion further includes a yoke including a cylindrical portion being cylindrical and arranged radially outside of the coil portion and radially inside of the mass portion;
the cylindrical portion of the yoke is fitted to a radially inner side of the mass portion through an adhesive; and
a portion of the adhesive is arranged in the positioning portion.

4. The vibration motor according to claim 1, wherein the coil portion and the elastic member are arranged one above the other in the vertical direction.

5. The vibration motor according to claim 1, wherein
the elastic member is arranged to extend radially inward and downward from the inner surface of the upper portion of the cover portion; and
the vibration motor further includes:
an adhesive layer fixed to an upper surface of the vibrating portion, and arranged in a circumferential direction below the elastic member; and
a viscous body in a paste, the viscous body being arranged in the circumferential direction on an upper surface of the adhesive layer, arranged vertically opposite to the elastic member, and including an upper end portion arranged at a level higher than a level of the upper surface of the vibrating portion.

6. The vibration motor according to claim 1, wherein
a lower edge of the cover portion includes a plurality of cuts each of which extends in a circumferential direction; and
a portion of the base portion is arranged to project radially outward from one of the cuts.

7. A silent notification device comprising the vibration motor of claim 1.

8. A method of manufacturing a vibration motor including:
a base portion arranged to extend perpendicularly to a central axis extending in a vertical direction;
a magnet portion fixed above the base portion;
an annular vibrating portion arranged around the magnet portion to vibrate in the vertical direction;
a cover portion in a shape of a covered cylinder, fixed to the base portion, and arranged to cover upper and lateral sides of the magnet portion and the vibrating portion; and
an annular elastic member arranged around the magnet portion between an inner surface of an upper portion of the cover portion and an upper portion of the vibrating portion, joined to both the upper portion of the cover portion and the upper portion of the vibrating portion, and including a central opening defined therein;
the vibrating portion including a coil portion arranged radially opposite to the magnet portion, and a mass portion arranged radially outside of the coil portion and including a central opening defined therein;
an inner edge portion of the elastic member being arranged radially inward of an inner circumferential edge of the mass portion, and including a positioning portion defined therein;
the method comprising:
a) inserting a jig through the central opening of the mass portion to support the mass portion by the jig;
b) inserting the jig through the central opening of the elastic member to support the elastic member on an upper side of the mass portion by the jig, while causing the positioning portion defined in the inner edge portion of the elastic member to be circumferentially engaged with the jig to fix a circumferential orientation of the elastic member;
c) joining the elastic member and an upper portion of the mass portion to each other at a first joint position in a circumferential direction of the elastic member;
d) covering the mass portion and the elastic member supported by the jig with the cover portion from an upper side to cover upper and lateral sides of the mass portion and the elastic member; and
e) joining the elastic member and the upper portion of the cover portion to each other at a second joint position in the circumferential direction of the elastic member through welding from above an outer surface of the upper portion of the cover portion.

9. The method of manufacturing the vibration motor according to claim 8, wherein
the vibration motor further includes a flexible circuit board arranged between the base portion and the vibrating portion, and joined to both an upper portion of the base portion and a lower portion of the vibrating portion;
the vibrating portion further includes a yoke including a cylindrical portion being cylindrical and arranged radially outside of the coil portion and radially inside of the mass portion; and
the method further comprises:
f) joining a lower portion of the yoke and an upper portion of the circuit board to each other; and
g) after step f), inserting the coil portion into a space radially inside of the cylindrical portion of the yoke to fit the coil portion to the yoke.

10. The method of manufacturing the vibration motor according to claim 9, the method further comprising:
h) after steps a) to e), inserting the cylindrical portion of the yoke with the coil portion fitted thereto as a result of step g) into a space radially inside of the mass portion from a lower side to fit the cylindrical portion to the mass portion; wherein
the coil portion and the elastic member are arranged one above the other in the vertical direction.

11. The method of manufacturing the vibration motor according to claim 10, wherein
the upper portion of the cover portion includes a hole portion defined therein; and
in step h), the hole portion is engaged with a second jig to fix a circumferential orientation of the cover portion.

12. The method of manufacturing the vibration motor according to claim 11, wherein
the positioning portion is a recessed portion recessed radially outward, and is engaged with a protruding portion arranged to project radially outward from an outer circumferential surface of the jig; and
in step h), the yoke is fitted to the mass portion through an adhesive, and a portion of the adhesive is pressed upwardly out of a gap between the yoke and the mass portion to be arranged in the positioning portion.

13. The method of manufacturing the vibration motor according to claim 8, wherein the positioning portion is a recessed portion recessed radially outward, and is engaged with a protruding portion arranged to project radially outward from an outer circumferential surface of the jig.
